(19) United States
(12) Patent Application Publication
(10) Pub. No.: US 2026/0035020 A1
(43) Pub. Date: Feb. 5, 2026

(54) METHOD FOR ASCERTAINING POTENTIAL TRAJECTORIES WHEN CONTROLLING A ROBOT DEVICE

(71) Applicant: Robert Bosch GmbH, Stuttgart (DE)

(72) Inventors: Aron Distelzweig, Schwanau (DE); Andreas Look, Wiesengiech (DE); Eitan Kosman, Haifa (IL)

(21) Appl. No.: 19/279,004

(22) Filed: Jul. 24, 2025

(30) Foreign Application Priority Data
Aug. 2, 2024 (EP) 24 19 2589.0

(51) Int. Cl. B60W 60/00; B60W 50/00; G05B 13/02

(52) U.S. Cl. CPC B60W 60/00274; B60W 50/0097; G05B 13/0265; B60W 2050/0022; B60W 2050/0028; B60W 2554/4045

(57) ABSTRACT

A method for controlling a robot device. The method includes: ascertaining potential trajectories of an object in the surrounding area of the robot device by ascertaining in each case one or more potential trajectories using one or more machine learning models and, for each of them, a weighting factor assigned thereto; ascertaining weighted similarity values by ascertaining a weighted similarity value for each of the potential trajectories, including: ascertaining a similarity value that represents a similarity between the potential trajectory and a set of proposed trajectories according to at least one similarity metric, and ascertaining the weighted similarity value by weighting the similarity value according to the weighting factor assigned to the potential trajectory; adapting the set of proposed trajectories to ascertain an adapted set of proposed trajectories that results in a reduced sum of the plurality of weighted similarity values.

### BACKGROUND INFORMATION

In at least partially automated (e.g., autonomous) driving, a vehicle planner can plan a future behavior of the vehicle based on a predefined number of potential future trajectories of another road user (e.g., another vehicle, a pedestrian, a cyclist, etc.) and the vehicle can be controlled accordingly. Here, the quality of planning (e.g., in terms of safety) can depend significantly on the selection of potential future trajectories.

Filos et al.: “Can Autonomous Vehicles Identify, Recover From, and Adapt to Distribution Shifts?”, arXiv: 2006.14911v2, 2020 (hereinafter referred to as Reference [1]) describes an assessment of potential trajectories by means of an ensemble of expert probability models and a selection of a subset of the potential trajectories based on the assessment.

### SUMMARY

The present invention relates to a method for controlling a robot device in which potential trajectories (e.g., of a road user) are not (as in Reference [1], for example) selected (randomly) from a set of potential trajectories, but are directly ascertained by optimizing a metric disclosed herein. This allows, for example, the diversity of the (selected) potential trajectories to be ensured in the case of a diverse future (i.e., many mutually different potential trajectories), and unnecessary diversity of the (selected) potential trajectories to be avoided in the case of a unimodal (i.e., non-diverse) future. The potential trajectories ascertained in this way can ensure robust and safe planning by the planner. This can significantly increase the efficiency of planning. This can also reduce the planning runtime, since the planning is only carried out for the selected potential trajectories and not all potential trajectories.

Various aspects of the present invention relate to a method for controlling a robot device. According to an example embodiment of the present invention, the method comprises: ascertaining a plurality of potential trajectories of an object (e.g., another robot device) in a surrounding area of the robot device by ascertaining in each case one or more potential trajectories by means of one or more machine learning models (e.g., an ensemble of Bayesian neural networks) and, for each of the one or more potential trajectories, a weighting factor assigned thereto; ascertaining a plurality of weighted similarity values by ascertaining a particular weighted similarity value for each potential trajectory of the plurality of potential trajectories, wherein ascertaining a weighted similarity value for a potential trajectory comprises: ascertaining a similarity value that represents a similarity between the potential trajectory and a set of proposed trajectories according to one or more similarity metrics (e.g., distance metrics), and ascertaining the weighted similarity value by weighting the (ascertained) similarity value according to the weighting factor assigned to the potential trajectory; summing the plurality of weighted similarity values to produce an error value; adapting (e.g., optimizing) the set of proposed trajectories in order to ascertain an adapted (e.g., optimized) set of proposed trajectories that results in a reduced (e.g., minimized) error value; generating control parameters for controlling the robot device using the adapted set of proposed trajectories; and controlling the robot device according to the control parameters.

Various exemplary embodiments of the present invention are specified below.

Example 1 is the method for controlling a robot device as described above.

Example 2 is configured according to Example 1, wherein each machine learning model of the one or more machine learning models comprises a (e.g., ensemble of) (e.g., Bayesian) neural network; and/or wherein the weighting factor assigned to a potential trajectory of the one or more potential trajectories represents an uncertainty of the potential trajectory.

In this way, uncertainty in relation to the respective model parameters and the particular architecture of the one or more machine learning models can be taken into account.

Example 3 is configured according to Example 1 or 2, wherein the plurality of trajectories is ascertained by ascertaining a plurality of trajectories by means of exactly one machine learning model.

The method disclosed herein makes ascertaining a predefined number of potential trajectories possible even in the case that the plurality of potential trajectories are predicted by means of a single machine learning model.

Example 4 is configured according to one of Examples 1 to 3, wherein the one or more similarity metrics comprise a minimum average distance error (minADE) between the potential trajectory and the set of proposed trajectories.

Example 5 is configured according to one of Examples 1 to 4, wherein the robot device is an at least partially automated vehicle, wherein the object is another road user, and wherein the one or more similarity metrics comprise an (off-road) metric that increases the similarity value if a proposed trajectory of the set of proposed trajectories is off-road.

As explained herein, one similarity metric can be used or a plurality of similarity metrics can be combined. The inventors have recognized that the minimum average distance error (minADE) as a similarity metric generally results in more robust and safe planning. The (off-road) metric can lead to an additional improvement in the case of at least partially automated driving (for example, in conjunction with the minADE similarity metric), since trajectories of other vehicles (i.e., if the object is another vehicle) that are off-road are given less weight.

Example 6 is configured according to one of Examples 1 to 5, wherein the proposed trajectories of the (initial) set of proposed trajectories are selected as a subset (randomly) from the plurality of potential trajectories. This can speed up the optimization process.

Example 7 is a control device that comprises one or more than one processor that is configured to perform the method according to one of Examples 1 to 6.

Example 8 is a robot device (e.g., an at least partially automated vehicle) that comprises the control device according to Example 7.

Example 9 is a computer program comprising commands that, when executed by a processor, cause the processor to perform the method according to one of examples 1 to 6.

Example 10 is a computer-readable medium that stores commands that, when executed by a processor, cause the processor to perform the method according to one of examples 1 to 6.

In the figures, similar reference signs generally refer to the same parts throughout the various views. The figures are not necessarily true to scale, with emphasis instead generally being placed on the representation of the principles of the present invention. In the following description, various aspects are described with reference to the figures.

### BRIEF DESCRIPTION OF THE DRAWINGS

FIG. 1 shows an at least partially automated vehicle according to various aspects of the present invention.

FIG. 2 shows a flow chart of a method for controlling the at least partially automated vehicle according to various aspects of the present invention.

FIG. 3A and FIG. 3B in each case show a set of potential trajectories of a road user ascertained according to the method 200 of the present invention.

### DETAILED DESCRIPTION OF EXAMPLE EMBODIMENTS

The following detailed description relates to the figures, which show, by way of explanation, specific details and aspects of this disclosure in which the present invention can be executed. Other aspects may be used, and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects.

Various examples are described in more detail below.

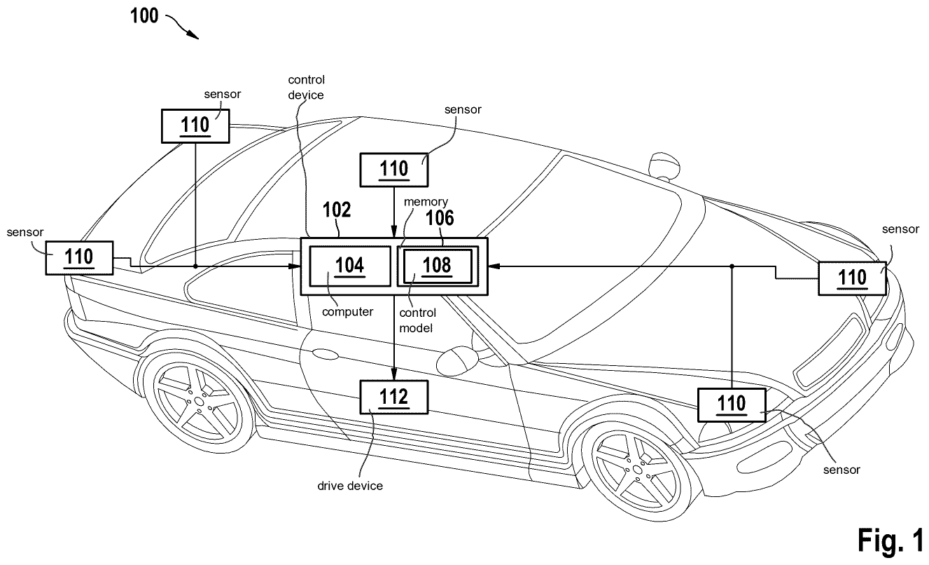

FIG. 1 shows an at least partially automated vehicle 100 according to various aspects. The at least partially automated vehicle 100 shown in FIG. 1 and described herein for illustrative purposes is an exemplary computer-controlled device. Although various aspects of the computer-implemented method are described herein in relation to the vehicle 100, it is understood that this is for illustrative purposes and that any other type of computer-controlled device can utilize the computer-implemented method in which trajectories of objects in the surrounding area of the computer-controlled device play a role, such as an industrial robot (e.g., in the form of a robot arm for moving, assembling or processing a workpiece, for retrieving containers, etc.), a manufacturing robot, a maintenance robot, a household robot (e.g., a cleaning robot, a lawnmower robot, etc.), a medical robot, etc.

For controlling the vehicle 100, the vehicle 100 can comprise a (vehicle) control device 102 that is configured to realize an interaction of the vehicle 100 with its surrounding area according to a control program. The term “control device” can be understood as any type of logical implementation unit that can include, for example, a circuit and/or a processor capable of executing software, firmware or a combination thereof stored in a storage medium, and that can issue instructions, e.g., to an actuator in the present example. The control device can be configured, for example, by program code (e.g., software) to control the operation of a system, in the present example a robot.

In the present example, the control device 102 can comprise a computer 104 and a memory 106 that stores code and data on the basis of which the computer 104 controls the vehicle 100. According to various aspects, the control device 102 can control the vehicle 100 based on a control model 108 stored in the memory 106.

In order to be able to control a driving task of the vehicle 100, the control device 102 can use sensor data that represent a surrounding area of the vehicle 100. For this purpose, the vehicle 100 can comprise one or more sensors 110, each of which can provide respective sensor data that represent at least part of the surrounding area of the vehicle 100. A sensor of the one or more sensors 110 can be, for example, an imaging sensor and/or a proximity sensor, such as a camera (e.g., a standard camera, a digital camera, an infrared camera, a stereo camera, etc.), a radar sensor, a LIDAR sensor, an ultrasonic sensor, etc. One of the one or more sensors 110 can be configured to detect an image that shows at least part of the surrounding area of the vehicle 100. An image can be an RGB image, an RGB-D image or a depth image (also referred to as a D-image). A depth image described herein may be any type of image that comprises depth information. Conceptually, a depth image can comprise 3-dimensional information about one or more objects in the surrounding area of the vehicle 100. For example, a depth image described herein can comprise a point cloud that is provided by a LIDAR sensor and/or a radar sensor. A depth image can, for example, be an image with depth information provided by a LIDAR sensor. It is understood that the vehicle 100 can further comprise other sensors, such as a Global Navigation Satellite System (GNSS, e.g., Global Positioning System, GPS), a speed sensor, an accelerometer, an altimeter sensor, a gyroscope, etc., and the control device 102 can also use sensor data provided by these other sensors to control the vehicle 100. The control device 102 can be configured to control the vehicle 100 in response to an input of the sensor data to the control model 108 based on an output of the control model 108.

The vehicle 100 can comprise a drive device 112 for driving the vehicle 100. The control device 102 can be configured to ascertain a control parameter for controlling the vehicle 100 using an output of the control model 108. The control device 102 can be configured to control the operation of the vehicle 100 (e.g., by controlling the drive device 112 by means of a control signal) according to the control parameters.

The at least partially automated vehicle 100 may be an automated vehicle or an autonomous vehicle. A vehicle's autonomy level can be ascertained or specified by an SAE (Society of Automotive Engineers) level (e.g., as defined in SAE J3016). For example, the at least partially automated vehicle 100 can be a partially automated vehicle (according to SAE Level 2), a highly automated vehicle (according to SAE Level 3), a fully automated vehicle (according to SAE Level 4) or an autonomous vehicle (according to SAE Level 5).

An at least partially automated vehicle can generally perform driving tasks autonomously. In order to ensure the safety of passengers and other road users (e.g., cyclists, pedestrians, etc.), systems that perform autonomous driving tasks must be highly safety-critical.

In order to plan future behavior of the vehicle 100, the control model 108 can comprise a planner. For this purpose, potential (future) trajectories of other road users can be fed to the planner. Here, the potential trajectories of another road user can be limited to a predefined number in order to limit the size of the search tree. Here, the robustness and safety of the planning can depend on the potential trajectories fed.

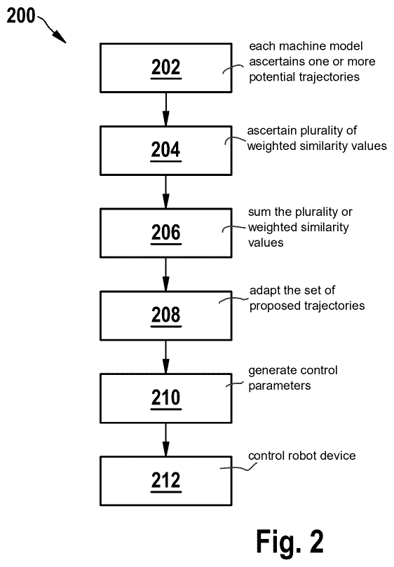

FIG. 2 shows a flow chart of a (computer-implemented) method 200 for controlling the at least partially automated vehicle 100 according to various aspects.

In the method 200, the predefined number of potential trajectories is not (as in Reference [1], for example) selected (randomly) from a set of potential trajectories, but is ascertained directly by optimizing a metric. This allows, for example, the diversity of the (selected) potential trajectories to be ensured in the case of a diverse future (i.e., many mutually different potential trajectories), and unnecessary diversity of the (selected) potential trajectories to be avoided in the case of a unimodal (i.e., non-diverse) future. The potential trajectories ascertained in this way can ensure the robust and safe planning by the planner.

The method 200 can comprise (in 202) ascertaining a plurality of potential trajectories of another road user in a surrounding area of the vehicle 100 by ascertaining in each case one or more potential trajectories by means of one or more machine learning models and, for each of the one or more potential trajectories, a weighting factor assigned thereto.

For example, based on the potential trajectories of other road users, it can be ensured during planning that regions potentially occupied by other road users are not driven into.

The method 200 can comprise (in 204) ascertaining a plurality of weighted similarity values by ascertaining a particular weighted similarity value for each potential trajectory of the plurality of potential trajectories. Ascertaining a weighted similarity value for a potential trajectory can comprise: ascertaining a similarity value that represents a similarity between the potential trajectory and a set of proposed trajectories according to one or more similarity metrics (e.g., distance metrics), and ascertaining the weighted similarity value by weighting the (ascertained) similarity value according to the weighting factor assigned to the potential trajectory.

The method 200 can comprise (in 206) summing the plurality of weighted similarity values to produce an error value.

The method 200 can comprise (in 208) adapting (e.g., optimizing) the set of proposed trajectories in order to ascertain an adapted (e.g., optimized) set of proposed trajectories that results in a reduced (e.g., minimized) error value.

The method 200 can comprise (in 210) generating control parameters for controlling the robot device using the adapted set of proposed trajectories.

The method 200 can comprise (in 212) controlling the robot device according to the control parameters.

Various aspects of the method 200 are described in more detail below.

In 202, each machine learning model fⁿ(x) of one or more machine learning models

$${\{ {f}^{n} ( x ) \}}_{n = 1}^{N}$$

can ascertain one or more potential trajectories

$${y}^{n} = {\{ {y}_{k}^{n} \}}_{k = 1}^{K}$$

and, for potential trajectory

$${y}_{k}^{n}$$

of one or more potential trajectories

$${\{ {y}_{k}^{n} \}}_{k = 1}^{K} ,$$

a weighting factor

$${w}^{n} = {w}_{k}^{n}$$

assigned thereto

$$( i . e . , {f}^{n} ( x ) \to {\{ {w}_{k}^{n} , {y}_{k}^{n} \}}_{k = 1}^{K} ) .$$

Conceptually, in this way, K*N potential trajectories (as the plurality of potential trajectories) can be ascertained with their respective assigned weighting factors

$${\{ {\{ {w}_{k}^{n} \}}_{k = 1}^{K} , {\{ {y}_{k}^{n} \}}_{k = 1}^{K} \}}_{n = 1}^{N} .$$

For ascertaining one or more potential trajectories

$${y}^{n} = {\{ {y}_{k}^{n} \}}_{k = 1}^{K} ,$$

the sensor data described above can be fed into a machine learning model fⁿ(x), for example. A potential trajectory described herein is a prediction of a future trajectory.

Here, “N” can be any integer greater than or equal to one and “K” can be any integer greater than or equal to one, as long as the factor K*N is greater than one. Conceptually, in the case of N=1, a single machine learning model f^{N}(x) can predict a plurality of potential trajectories

$${\{ {y}_{k}^{N} \}}_{k = 1}^{K}$$

(with K>1, and in the case of K=1, a plurality of machine learning models

$${\{ {f}^{n} ( x ) \}}_{n = 1}^{N}$$

(with N>1) can in each case predict exactly one potential trajectory K.

For example, a machine learning model can be a (e.g., Bayesian) neural network and the weighting factor assigned to a potential trajectory ascertained by means of this (Bayesian) neural network can represent an uncertainty of the potential trajectory.

The inventors have recognized that this plurality of potential trajectories with their respective associated weighting factors

$${\{ {\{ {w}_{k}^{n} \}}_{k = 1}^{K} , {\{ {y}_{k}^{n} \}}_{k = 1}^{K} \}}_{n = 1}^{N}$$

can be considered to be a weighted Dirac delta function (also referred to as a weighted Dirac distribution):

$$q ( y ) = {\sum }_{k} {\sum }_{n} {w}_{k}^{n} δ ( {y}_{k}^{n} - y ) .$$

This consideration makes possible the metric disclosed herein for directly ascertaining the (optimized) set of potential trajectories

$$\hat{y} = {\{ {\hat{y}}_{s} \}}_{s = 1}^{S}$$

(with 1≤MS=K*N). Thus, this metric is optimized according to various aspects so that the set of potential trajectories

$${\{ {\hat{y}}_{s} \}}_{s = 1}^{S}$$

can be ascertained directly and does not have to be selected from the plurality of trajectories

$${\{ {\{ {y}_{k}^{n} \}}_{k = 1}^{K} \}}_{n = 1}^{N} .$$

If the set of potential trajectories were selected directly from the plurality of trajectories, possible scenarios could be overlooked, which could be hazardous to safety (e.g., lead to accidents).

In 204, the particular weighted similarity value can then be ascertained for each potential trajectory

$${y}_{k}^{n}$$

of the one or more potential trajectories

$${\{ {y}_{k}^{n} \}}_{k = 1}^{K} .$$

For this purpose, a similarity value can be ascertained, which represents a similarity between the potential trajectory

$${y}_{k}^{n}$$

and the set of proposed trajectories

$$\hat{y} = {\{ {\hat{y}}_{s} \}}_{s = 1}^{S}$$

according to one or more similarity metrics (e.g., distance metrics). For the purpose of illustration, one or more similarity metrics can be the minimum average distance error (minADE). In this case, the similarity value can result from:

$$min {ADE}_{S} ( {y}_{k}^{n} , \hat{y} ) = {min}_{s} {\{ {‖ {y}_{k}^{n} - {\tilde{y}}_{s} ‖}_{2} \}}_{s = 1}^{S} .$$

Since the similarity between each potential trajectory

$${y}_{k}^{n}$$

and the set of proposed trajectories

$$\hat{y} = {\{ {\hat{y}}_{s} \}}_{s = 1}^{S}$$

is taken into account, in the case of a diverse scenario (i.e., in the case of many different potential trajectories, for example, in different directions), a diversity of (selected) potential trajectories can be ensured. If the plurality of trajectories

$${\{ {\{ {y}_{k}^{n} \}}_{k = 1}^{K} \}}_{n = 1}^{N}$$

at an intersection comprises, for example, trajectories to the left, trajectories to the right, and trajectories straight ahead, then by means of the method 200 it can be ensured that the set of proposed trajectories

$$\hat{y} = {\{ {\hat{y}}_{s} \}}_{s = 1}^{S}$$

also comprises at least one trajectory to the left, at least one trajectory to the right, and at least one trajectory straight ahead.

The minimum average distance error minADE indicates the minimum deviation error between the potential trajectory

$${y}_{k}^{n}$$

and the set of potential trajectories

$$\tilde{y} = {\{ {\tilde{y}}_{s} \}}_{s = 1}^{S}$$

(to be optimized). It is understood that the minADE is for illustrative purposes only and that any other (optimizable) similarity metric can be used additionally or alternatively. For example, the (off-road) metric can be used additionally or alternatively, according to which the similarity value is increased if the potential trajectory

$${y}_{k}^{n}$$

of the owner road user is off-road.

In this example, the smaller the similarity value, the greater the similarity between the potential trajectory

$${y}_{k}^{n}$$

and the set of proposed trajectoies

$$\tilde{y} = {\{ {\tilde{y}}_{s} \}}_{s = 1}^{S} .$$

It is understood that this is exemplary and can be common for various similarity metrics (e.g., distance metrics), but that the reverse may also be the case.

The weighted similarity value can then be ascertained by weighting the (ascertained) similarity value according to the weighting factor

$${w}_{k}^{n}$$

assigned to the potential trajectory

$${y}_{k}^{n} .$$

the weighted similarity value can therefore result from:

$${w}_{k}^{n} min {ADE}_{S} ( {y}_{k}^{n} , \hat{y} ) .$$

In 206, the K*N weighted similarity values can then be summed to produce an error value. The error value can therefore result from:

$${\sum }_{k} {\sum }_{n} {w}_{k}^{n} min {ADE}_{S} ( {y}_{k}^{n} , \hat{y} ) .$$

In 208, the set of proposed trajectories y can then be adapted (e.g., optimized) in order to reduce (e.g., minimize) the error value. Optimization can be done according to:

$$\tilde{y} = {\{ {\tilde{y}}_{s} \}}_{s = 1}^{S} = {argmin}_{\tilde{y} = {\{ {\tilde{y}}_{s} \}}_{s = 1}^{S}} {𝔼}_{y ∼ q ( y )} [ {min}_{s} {\{ {‖ y - {\tilde{y}}_{s} ‖}_{2} \}}_{s = 1}^{S} ] = {argmin}_{{\{ {\tilde{y}}_{s} \}}_{s = 1}^{S}} {𝔼}_{y ∼ q ( y )} [ min {ADE}_{S} ( y , \tilde{y} ) ] ,$$

where

$$\tilde{y} = {\{ {\tilde{y}}_{s} \}}_{s = 1}^{S}$$

is the set of potential trajectories to be optimized and

$$\tilde{y} = {\{ {\tilde{y}}_{s} \}}_{s = 1}^{S}$$

is the optimized set of potential trajectories. This optimization of the set of potential trajectories can be considered to be approximate empirical risk minimization under the distribution from the plurality of trajectories

$${\{ {\{ {y}_{k}^{n} \}}_{k = 1}^{K} \}}_{n = 1}^{N} .$$

Ascertaining the set of potential trajectories ŷ according to steps 202 to 206 of the method 200 is shown by way of example for minADE as a similarity metric in Algorithm 1. The trajectories of the initial set of potential trajectories ŷ can be selected randomly, can be selected randomly from the plurality of trajectories

$${\{ {\{ {y}_{k}^{n} \}}_{k = 1}^{K} \}}_{n = 1}^{N} ,$$

and/or can be selected by means of a machine learning model.

Algorithm 1: Ascertaining the set of potential trajectories ŷ

```
Input:  A plurality of potential trajectories with the particular
        $associated weighting factor {\{ {\{ {w}_{k}^{n} \}}_{k = 1}^{K} , {\{ {y}_{k}^{n} \}}_{k = 1}^{K} \}}_{n = 1}^{N}$
        Number S of potential trajectories
$Output : Set of potential trajectories \hat{y} = {\{ {\hat{y}}_{s} \}}_{s = 1}^{S}$
Initialize the (initial) set of potential trajectories ŷ.
Optimize ŷ:
  As long as not converged, perform
        $Error value = {\sum }_{k} {\sum }_{n} {w}_{k}^{n} min {ADE}_{S} ( {y}_{k}^{n} , \hat{y} ) .$
        Adapt the set of proposed trajectories to reduce the
        error value (e.g., by means of backpropagation).
        Next optimization step.
  Return ŷ
```

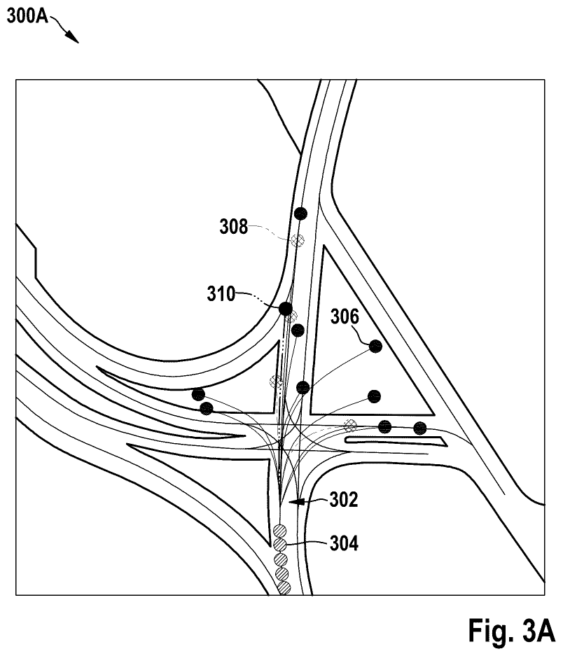

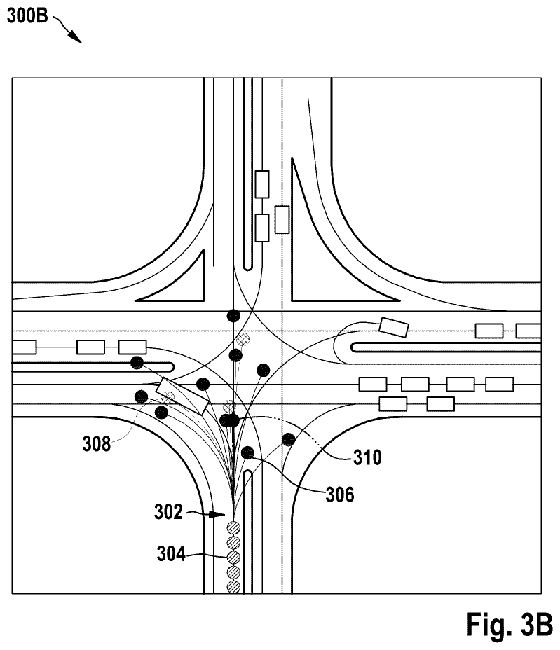

FIG. 3A shows a first traffic scenario 300A, and FIG. 3B shows a second traffic scenario 300B, in which, for a road user 302 who has traveled along a past trajectory 304 (shown as cross-hatching), according to the method 200, the plurality of potential (future) trajectories 306 (shown as solid lines with a filled endpoint) is ascertained together with the particular associated weighting factor

$$: {\{ {\{ {w}_{k}^{n} \}}_{k = 1}^{K} , {\{ {y}_{k}^{n} \}}_{k = 1}^{K} \}}_{n = 1}^{N} ,$$

and, based thereon, the (optimized) set of potential (future) trajectories 308, ŷ, (shown as dashed lines with an endpoint in cross-hatching) is ascertained for S=5. The dash-dot line 310 represents the ground truth trajectory, i.e., the trajectory that the road user 302 has traveled in the future. That the trajectories of the (optimized) set of potential trajectories 308, ŷ, is not a selection from the plurality of potential trajectories 306, can be conceptually seen, for example, in FIG. 3B, since the potential trajectory marked 308 does not match any of the trajectories of the plurality of potential trajectories 306.

Although in the above embodiments the approach of FIG. 2 is applied to control the vehicle 100, it can generally be applied to ascertain a control signal for controlling any technical system in a scenario in which a limited set of potential (future) trajectories play a role, such as a computer-controlled machine such as a robot, a vehicle, a household appliance, a power tool, a manufacturing machine, a personal assistant or an access control system. According to various aspects, a method for predicting a behavior of a road user can comprise steps 202 to 208 of method 200.

1-10. (canceled)

11. A method for controlling a robot device, the method comprising the following steps:
ascertaining a plurality of potential trajectories of an object in a surrounding area of the robot device by ascertaining in each case one or more potential trajectories using one or more machine learning models and, for each potential trajectory of the one or more potential trajectories, a weighting factor assigned to the trajectory;
ascertaining a plurality of weighted similarity values by ascertaining a respective weighted similarity value for each potential trajectory of the plurality of potential trajectories, wherein the ascertaining of the respective weighted similarity value for a potential trajectory includes:
ascertaining a similarity value that represents a similarity between the potential trajectory and a set of proposed trajectories according to one or more similarity metrics, and
ascertaining the respective weighted similarity value by weighting the similarity value according to the weighting factor assigned to the potential trajectory;
summing the plurality of weighted similarity values to produce an error value;
adapting the set of proposed trajectories to ascertain an adapted set of proposed trajectories that results in a reduced error value;
generating control parameters for controlling the robot device using the adapted set of proposed trajectories; and
controlling the robot device according to the control parameters.

12. The method according to claim 11, wherein:
each machine learning model of the one or more machine learning models includes a Bayesian neural network; and/or
the weighting factor assigned to a potential trajectory of the one or more potential trajectories represents an uncertainty of the potential trajectory.

13. The method according to claim 11, wherein the plurality of trajectories is ascertained by ascertaining a plurality of trajectories using exactly one machine learning model.

14. The method according to claim 11, wherein the one or more similarity metrics include a minimum average distance error between the potential trajectory and the set of proposed trajectories.

15. The method according to claim 11, wherein the robot device is an at least partially automated vehicle, wherein the object is another road user, and wherein the one or more similarity metrics include a metric that increases the similarity value when the proposed trajectory of the set of proposed trajectories is off-road.

16. The method according to claim 11, wherein the proposed trajectories of the set of proposed trajectories are selected as a subset from the plurality of potential trajectories.

17. A control device configured to control a robot device, the control device configured to:
ascertain a plurality of potential trajectories of an object in a surrounding area of the robot device by ascertaining in each case one or more potential trajectories using one or more machine learning models and, for each potential trajectory of the one or more potential trajectories, a weighting factor assigned to the trajectory;
ascertain a plurality of weighted similarity values by ascertaining a respective weighted similarity value for each potential trajectory of the plurality of potential trajectories, wherein the ascertaining of the respective weighted similarity value for a potential trajectory includes:
ascertaining a similarity value that represents a similarity between the potential trajectory and a set of proposed trajectories according to one or more similarity metrics, and
ascertaining the respective weighted similarity value by weighting the similarity value according to the weighting factor assigned to the potential trajectory;
sum the plurality of weighted similarity values to produce an error value;
adapt the set of proposed trajectories to ascertain an adapted set of proposed trajectories that results in a reduced error value;
generate control parameters for controlling the robot device using the adapted set of proposed trajectories; and
control the robot device according to the control parameters.

18. A robot device, comprising:
a control device configured to control the robot device, the control device configured to:
ascertain a plurality of potential trajectories of an object in a surrounding area of the robot device by ascertaining in each case one or more potential trajectories using one or more machine learning models and, for each potential trajectory of the one or more potential trajectories, a weighting factor assigned to the trajectory;
ascertain a plurality of weighted similarity values by ascertaining a respective weighted similarity value for each potential trajectory of the plurality of potential trajectories, wherein the ascertaining of the respective weighted similarity value for a potential trajectory includes:
ascertaining a similarity value that represents a similarity between the potential trajectory and a set of proposed trajectories according to one or more similarity metrics, and
ascertaining the respective weighted similarity value by weighting the similarity value according to the weighting factor assigned to the potential trajectory;
sum the plurality of weighted similarity values to produce an error value;
adapt the set of proposed trajectories to ascertain an adapted set of proposed trajectories that results in a reduced error value;
generate control parameters for controlling the robot device using the adapted set of proposed trajectories; and
control the robot device according to the control parameters.

19. A non-transitory computer-readable medium in which is stored commands for controlling a robot device, the command, when executed by a processor, causing the processor to perform the following steps:
ascertaining a plurality of potential trajectories of an object in a surrounding area of the robot device by ascertaining in each case one or more potential trajectories using one or more machine learning models and, for each potential trajectory of the one or more potential trajectories, a weighting factor assigned to the trajectory;
ascertaining a plurality of weighted similarity values by ascertaining a respective weighted similarity value for each potential trajectory of the plurality of potential trajectories, wherein the ascertaining of the respective weighted similarity value for a potential trajectory includes:
ascertaining a similarity value that represents a similarity between the potential trajectory and a set of proposed trajectories according to one or more similarity metrics, and
ascertaining the respective weighted similarity value by weighting the similarity value according to the weighting factor assigned to the potential trajectory;
summing the plurality of weighted similarity values to produce an error value;
adapting the set of proposed trajectories to ascertain an adapted set of proposed trajectories that results in a reduced error value;
generating control parameters for controlling the robot device using the adapted set of proposed trajectories; and
controlling the robot device according to the control parameters.
